(19) United States
(12) Patent Application Publication
(10) Pub. No.: US 2026/0354315 A1
(43) Pub. Date: Nov. 12, 2026

(54) REINFORCED POT, KIT AND METHOD BASED ON SUCH A POT

(71) Applicant: Alexandre DALUZ, Aramon (FR)

(72) Inventor: Alexandre DALUZ, Aramon (FR)

(21) Appl. No.: 19/124,031

(22) PCT Filed: Oct. 26, 2023
(86) PCT No.: PCT/IB2023/060801

§ 371 Date: Apr. 24, 2025

(30) Foreign Application Priority Data
Oct. 28, 2022 (FR) FR2211286
Dec. 19, 2022 (FR) FR2213872

(51) Int. Cl. A01G 9/12; A01G 9/02

(52) U.S. Cl. CPC A01G 9/124; A01G 9/02

(57) ABSTRACT

The invention relates to a kit, a method, and a pot with reinforcement forming a receptacle for soil and plant, comprising:
a pot bottom (3);
a pot wall (1);
   characterized in that the pot with reinforcement further comprises a stake support (4)
   fixed or positioned on the pot bottom (3), projecting above the pot bottom (3) with reference to a vertical axis (Z), and being at least partially surrounded by the pot wall (1);
   and in that the stake support (4) comprises an attachment means (5) to connect and/or fix a stake (10) to the stake support (4).

The invention allows for mechanical reinforcement of the stake (10) and protects it from damage caused by the moistened soil.

The present invention relates to the field of pots or other cultivation containers, for use as flowerpots or plant pots, especially those coupled with a stake to support the plant (i.e.: a rod that supports a plant throughout its growth).

The invention more specifically concerns a new type of pot.

In the prior art, pots have been proposed, but their shapes have not adequately addressed the following:
1°) maintaining the stake upright due to the natural compaction of the soil over time;
2°) preventing the stake from deteriorating due to moisture from the soil.

Indeed, such pots are generally used with stakes made of natural materials such as wood, to ensure better natural compatibility with the cultivated plant.

In use, the stake is planted in potting soil, which is regularly watered. As a result, the potting soil represents an unstable substrate for the mechanical stability of the stake, so that it eventually falls out.

In addition, biological organisms develop in the potting soil and eventually damage the stake, so that it is degraded and cannot hold its position.

Therefore, the aim of the present invention is to overcome the shortcomings of the prior art, particularly by offering a solution to improve the mechanical stability of the stake and to prevent its premature degradation.

To achieve this objective, the invention proposes a pot with reinforcement forming a receptacle for soil and plant, in a spatial reference comprising a vertical axis following a vertical direction, a lateral axis perpendicular to the vertical axis, and a thickness axis perpendicular to the vertical axis and to the lateral axis, the pot with reinforcement comprising:
a pot bottom;
a pot wall;
   characterized in that the pot with reinforcement further comprises a stake support fixed or arranged on the pot bottom, and forming a projection above the pot bottom with reference to the vertical axis, being at least partially surrounded by the pot wall;
   and in that the stake support comprises an attachment means for connecting and/or fixing a stake to the stake support.

The term “pot” refers to a structure that is essentially prismatic, cylindrical, or otherwise shaped to receive one or more plants. This term includes any container or planter shaped as a receptacle.

According to several embodiments, isolated or in any technically feasible combination:
the attachment means comprises a first sleeving structure configured to cooperate with a second complementary sleeving structure of the stake; and/or
the first sleeving structure is external, and the second sleeving structure is internal, with reference to the lateral axis and to the thickness axis; and/or
the stake support has an external cylindrical shape with reference to the lateral axis and to the thickness axis; and/or
the stake support is hollow and has an internal shape that is conical or frustoconical, the revolution diameter of which tapering downward with reference to the vertical axis, the internal shape forming the attachment means; and/or
the stake support extends vertically to a height above that of the pot wall with reference to the vertical axis; or more generally, the stake support is configured to prevent contact between the stake and the elements contained within the pot with reinforcement; and/or
the pot bottom comprises at least one hole configured to receive another stake support; and/or
the pot with reinforcement further comprises reinforcement structures for the stake support, with a triangular or trapezoidal cross-section, the reinforcement structures being disposed and/or fixed at the base of the stake support and on the pot bottom; and/or
the pot wall has a circular cross-section shape; and/or
the pot wall has a round or oval horizontal cross-section shape; and/or
the pot wall has a polygonal cross-section shape; and/or
the pot wall has a square or rectangular horizontal cross-section shape.

The invention also relates to a plant cultivation kit comprising:
at least one pot with reinforcement according to the invention; and/or
at least one stake configured to be connected and/or fixed to the stake support of one or the pot with reinforcement according to the invention.

Another object of the invention is a plant cultivation method comprising at least one step of using at least one pot with reinforcement according to the invention; and/or at least one stake configured to be connected and/or fixed to the stake support of one or the pot with reinforcement according to the invention.

The invention will be described in further detail through non-limiting exemplary embodiments and based on the appended figures illustrating preferred embodiments of the invention, in which:

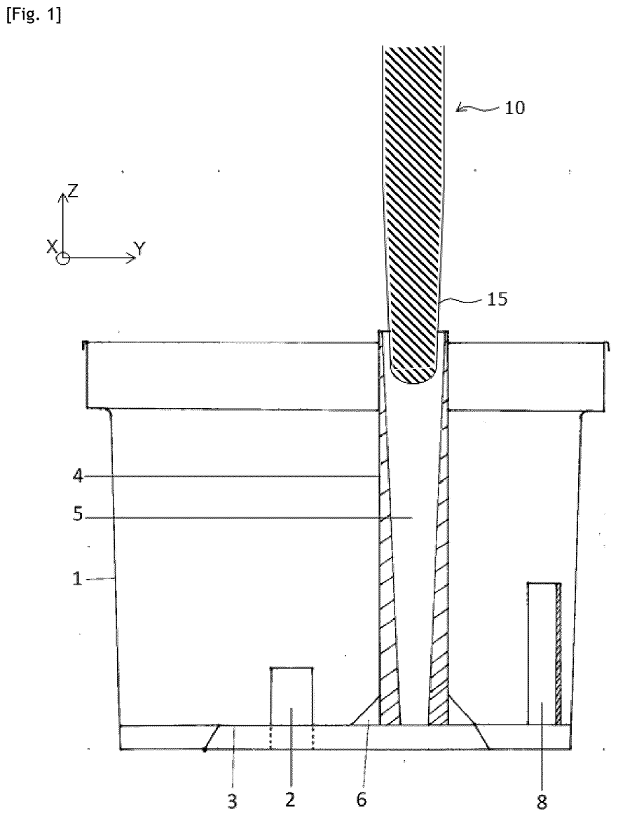

FIG. 1 is a cross-sectional view of a pot with reinforcement according to the invention, showing the stake support and the interior of the pot;

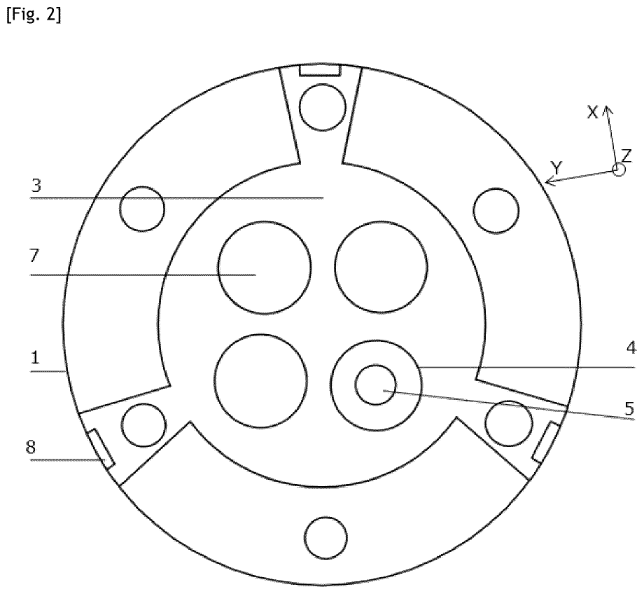

FIG. 2 is a top view of a pot with reinforcement according to the invention;

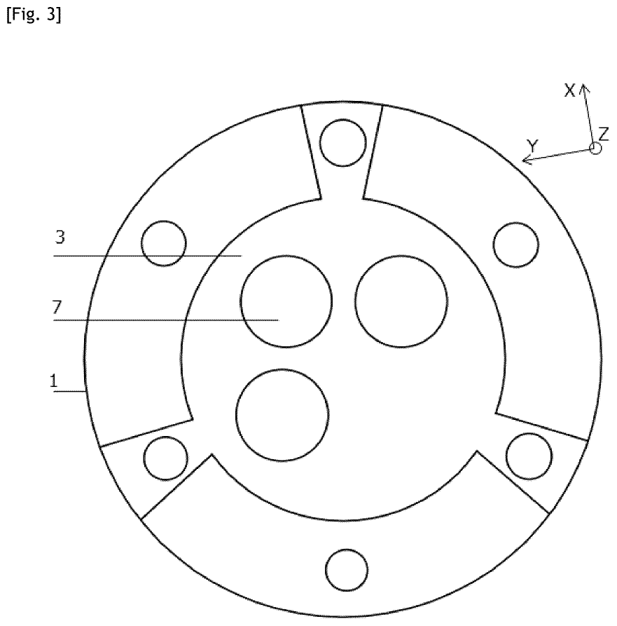

FIG. 3 is a bottom view of a pot with reinforcement according to the invention.

With reference to these figures, the pot with reinforcement preferably comprises:
a wall 1;
ventilation holes 2;
a raised bottom 3;
a stake support 4, here cylindrical;
an attachment means 5, here in the form of a hollow internal part of the stake support 4, and shaped like a truncated cone;
reinforcements 6, with a triangular cross-section, here in the shape of a triangle;
holes 7 for receiving additional stake supports 4, for stacking the pots, here preferably three holes 7, which are circular ;
stops 8 for stacking, preferably three, here in the shape of a rectangle, arranged against the wall 1.

The pot is described with reference to a spatial reference comprising a vertical axis Z following a vertical direction, a lateral axis Y perpendicular to the vertical axis Z, and a thickness axis X perpendicular to the vertical axis Z and to the lateral axis Y.

The pot with reinforcement includes a stake support 4 that prevents the stake 10 from coming into direct contact with the moist soil in the pot, which would otherwise cause its degradation.

This stake support 4 also helps to solidify the lower part of the stake 10, preventing it from falling under the weight of the plant.

The stake support 4 is slightly taller than the walls 1 of the pot to provide better stability for the plant.

The exterior of the stake support 4 is cylindrical in shape to allow for plastic injection molding production.

The interior of the stake support 4 is in the shape of a cylindrical cone with a smaller diameter at the starting point and a larger finishing point, allowing several diameters of stakes 10 to be inserted into the support 4.

Three holes 7 are placed at the bottom 3 of the pot with reinforcement, including a raised bottom 3 to allow for infinite stacking of the pots.

Triangular reinforcements 6 are placed at the bottom of the stake support 4 to provide better stability for the plant. These reinforcements may be annular.

Three stops 8 are placed at the bottom 3 of the pot against the wall 1 and at the three ends of the raised bottom to allow the pots to be stacked infinitely.

The pot preferably includes a first wall 1 to maintain the pot's capacity, with a second, wider wall at the top to facilitate handling of the pot by hand.

Ventilation holes 2 may be provided on the side of the pot to allow the plants to better absorb water.

A raised bottom 3 of the pot may be provided to allow water to pass underneath the pot.

Additional holes may be provided at the bottom 3 of the pot to allow the plants to absorb water.

In the context of the invention, the pot's wall 1 can have a shape adapted to the typical pots used and the aesthetic desired by the user. Thus, the shape of the pot's wall 1 may be cylindrical, conical, or truncated conical with a circular horizontal cross-section, such as round or oval.

Alternatively, the shape of the pot's wall 1 may be prismatic with a polygonal horizontal cross-section, such as square or rectangular. Aside from aesthetics, the polygonal shape is preferred to minimize dead space on the sides of the pot when storing. This is especially true for three-or four-sided shapes, such as triangular, square, or rectangular forms.

1. A pot with reinforcement forming a receptacle for soil and plant, in a spatial reference comprising a vertical axis following a vertical direction, a lateral axis perpendicular to the vertical axis and a thickness axis perpendicular to the vertical axis and to the lateral axis, the pot with reinforcement comprising:
a pot bottom;
a pot wall;
wherein the pot with reinforcement further comprises a stake support fixed or arranged on the pot bottom, and forming a projection above the pot bottom with reference to the vertical axis, being at least partially surrounded by the pot wall;
wherein the stake support comprises an attachment means for connecting and/or fixing a stake to the stake support.

2. The pot with reinforcement according to claim 1, characterized in that the attachment means comprises a first sleeving structure configured to cooperate with a second complementary sleeving structure of the stake.

3. The pot with reinforcement according to claim 1, characterized in that the first sleeving structure is external, and the second sleeving structure is internal, with reference to the lateral axis and to the thickness axis.

4. The pot with reinforcement according to claim 1, characterized in that the stake support has an external cylindrical shape with reference to the lateral axis and to the thickness axis.

5. The pot with reinforcement according to claim 1, characterized in that the stake support is hollow and has an internal shape that is conical or frustoconical, the revolution diameter of which tapering downward with reference to the vertical axis, the internal shape forming the attachment means.

6. The pot with reinforcement according to claim 1, characterized in that the stake support extends vertically to a height above that of the pot wall with reference to the vertical axis.

7. The pot with reinforcement according to claim 1, characterized in that the pot bottom comprises at least one hole configured to receive another stake support.

8. The pot with reinforcement according to claim 1, characterized in that it further comprises reinforcement structures for the stake support, with a triangular or trapezoidal cross-section, the reinforcement structures being disposed and/or fixed at the base of the stake support and on the pot bottom.

9. The pot with reinforcement according to claim 1, characterized in that the pot wall has a circular cross-section shape.

10. The pot with reinforcement according to claim 9, characterized in that the pot wall has a round or oval horizontal cross-section shape.

11. The pot with reinforcement according to claim 1, characterized in that the pot wall has a polygonal cross-section shape.

12. The pot with reinforcement according to claim 1, characterized in that the pot wall has a square or rectangular horizontal cross-section shape.

13. A plant cultivation kit comprising:
at least one pot with reinforcement according to claim 1; and/or
at least one stake configured to be connected and/or fixed to the stake support of one or the pot with reinforcement according to claim 1.

14. A plant cultivation method comprising at least one step of using at least one pot with reinforcement according to claim 1; and/or at least one stake configured to be connected and/or fixed to the stake support of one or the pot with reinforcement according to claim 1.
